(19) United States
(12) Patent Application Publication
(10) Pub. No.: US 2004/0115336 A1
(43) Pub. Date: Jun. 17, 2004

(54) Method of fabricating a grating-based optical biosensor

(75) Inventors: Kang-Ping Lin, Taoyuan (TW); Yuh-Ping Tong, Taoyuan (TW); Chia-Yu Chang, Ilan (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/317,116

(22) Filed: Dec. 12, 2002

(51) Int. Cl. C08J 7/18

(52) U.S. Cl. 427/2.11

(57) ABSTRACT

A method of fabricating a grating-based optical biosensor. The probes of the grating-based optical biosensor are applied in a probe solution as probes. The probe solution is provided on a substrate, and the substrate is exposed to a light pattern having a light area and a dark area, so that the probes of the probe solution are gathered in the light area of the light pattern. Finally, the probes are fixed on the substrate to form the biosensor.

### BACKGROUND OF THE INVENTION

1. Field of the Invention

The present invention relates to a method of fabricating a grating-based optical biosensor.

2. Description of the Related Art

Conventionally, a biosensor consists of two parts: a first layer that responds to the presence of a specific chemical, such as a chemical in a sample, and a second layer that translates this specific interaction into electric signals proportional to the concentration of the chemical in the sample. Optical devices can be applied to form the second layer of the biosensor to translate the specific interaction into optical signals. This device is generally regarded as an optical biosensor.

Generally, a plurality of probes is deployed to the first layer of the biosensor to perform the specific interaction. These probes can be deployed either mechanically or electrically. For the grating-based optical biosensor, a desired pattern for the probe deployment is required on the biosensor, so that the probes can be assembled into the desired pattern. Thus, the pattern translates the specific interaction into different diffraction phenomenon. Conventionally, the desired pattern is formed by stamping or UV mask photolithography. In an example of stamping as described in U.S. Pat. No. 6,060,256, the desired pattern is formed by printing a predetermined pattern on a metalized plastic film. In a further example of UV mask photolithography as taught in U.S. Pat. No. 4,876,208, the desired pattern is formed through a photo mask.

However, in the conventional method to obtain the desired pattern by stamping or UV mask photolithography, the pressing stamp for stamping or the photo mask for performing UV mask photolithography are required. It goes without saying that fabrication of the pressing stamp or the photo mask increases the fabrication cost and time of the grating-based optical biosensor. Further, once the desired pattern is about to be modified, the pressing stamp or the photo mask is not easily reused, and application of a new pressing stamp or a new photo mask further increases the fabrication cost and time. Therefore, there is an important subject to search for a simple, flexible, and economical method to fabricate the grating-based optical biosensor.

### SUMMARY OF THE INVENTION

In view of this, an object of the present invention is to provide a method of fabricating a grating-based optical biosensor without application of the conventional pressing stamp or the photo mask, so that the grating-based optical biosensor is fabricated at a relatively low cost and short time.

The present invention discloses a method of fabricating a grating-based optical biosensor. The probe solution is provided on a substrate, and the substrate is exposed to a light pattern having a light area and a dark area, so that the probes of the probe solution are gathered in the light area of the light pattern. Finally, the probes are fixed on the substrate to form the biosensor.

In the above-mentioned method of the present invention, the light pattern can be obtained by providing a laser light source for directing a laser beam along a light path, and providing a beam splitter and a plurality of mirrors in the light path. Thus, the beam splitter splits the laser beam to two light beams, and the mirrors reflect the two light beams respectively onto the substrate to form the light pattern by light interference.

Further, the present invention discloses an apparatus for fabricating a grating-based optical biosensor. The apparatus has a laser light source for directing a laser beam along a light path, a beam splitter provided in the light patch for splitting the laser beam to two light beams, and a plurality of mirrors disposed for reflecting the two light beams respectively onto a substrate to form a light pattern by light interference, in which a probe solution is provided on the substrate, and the probes of the probe solution are gathered in a light region of the light pattern.

In the present invention, the probe can be an antigen, an antibody, a ligand, a receptor, a peptide, a nucleotide, or any particle with these species combined thereon. Otherwise, the probe can be a specific gel capable of responding to a stimulus, as described in U.S. Pat. No. 6,180,288.

Further, the probes can be fixed on the substrate by removing the solvent; for example, the solvent can be removed by evaporation. Otherwise, the probes can be provided with a plurality of functional groups thereon, so that the probes are fixed on the substrate by activating the functional groups with light.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic view showing an embodiment of the present invention, in which the probe solution is provided on the substrate;

FIG. 2a is a top view showing an embodiment of the apparatus for fabricating a grating-based optical biosensor of the present invention;

FIG. 2b is a side view showing the embodiment in FIG. 2a; and

FIG. 3 is a flowchart showing the method of fabricating a grating-based optical biosensor of the present invention.

### DETAILED DESCRIPTION OF THE INVENTION

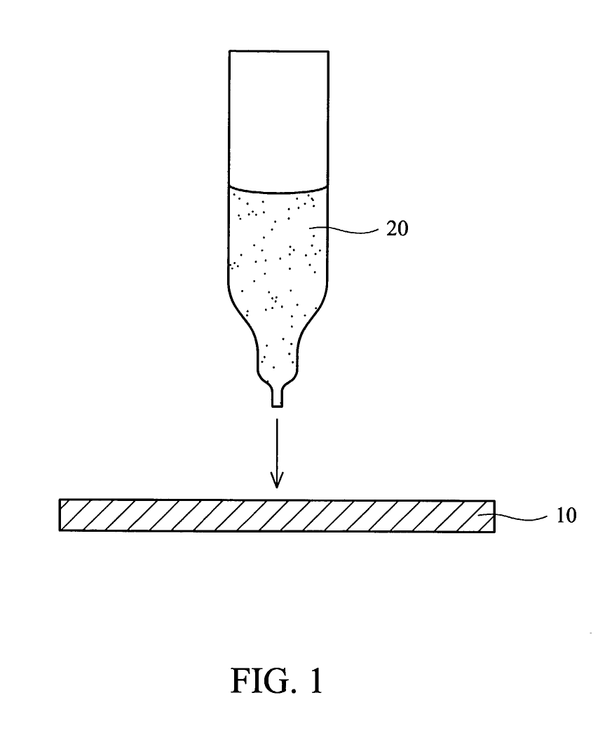

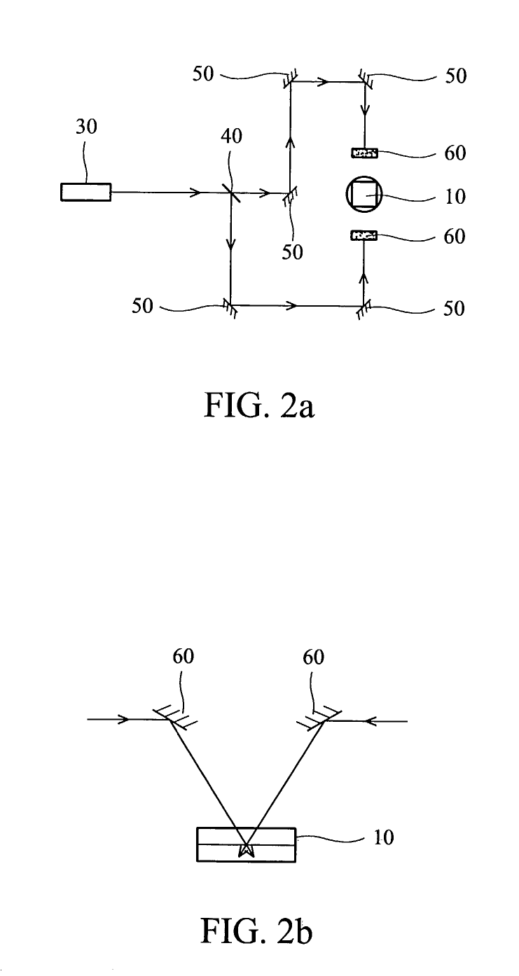

The present invention can be described with an embodiment in detail with reference to FIGS. 1, 2a and 2b.

The present invention discloses a method of fabricating a grating-based optical biosensor. As above-mentioned, a plurality of probes is optically deployed to the first layer of the grating-based optical biosensor to perform the specific interaction. Consequently, the probes can be provided in a form of a probe solution 20 on a substrate 10 of the biosensor, as shown in FIG. 1. The probe solution 20 has a plurality of probes and a solvent, in which the probes in practical application can be, but are not limited to, antigens, antibodies, ligands, receptors, peptides, nucleotides, or particles with these species combined thereon, as well as the specific gel capable of responding to a stimulus, as described in U.S. Pat. No. 6,180,288. The particles of the present invention can be gathered or trapped by light and the desirable particle size ranges from a diameter of approximately 1 nm to 100 um. The solvent can be a volatile liquid, such as water.

An embodiment of the apparatus for fabricating a grating-based optical biosensor is shown in FIGS. 2a and 2b. The apparatus has a laser light source 30, a beam splitter 40, and a plurality of mirrors 50, which includes two tilt mirrors 60. The laser light source 30 directs a laser beam along a light path toward the beam splitter 40, which is provided in the light path, as shown in FIG. 2a. The beam splitter 40 then splits the laser beam to two separate light beams. In FIG. 2a, one light beam passes the beam splitter 40, and the other light beam is reflected to go downward by the beam splitter 40. Further, the mirrors 50 are disposed on the paths of the two separate light beams, so that the two separate light beams can be respectively reflected by the tilt mirrors 60 onto the substrate 10 to form a light pattern by light interference. The mirrors 50 and 60 can be disposed three-dimensionally; for example, the two tilt mirrors 60 disposed near the substrate 10 in FIG. 2a can be disposed with a tilting angle relative to the paths of the light beams, so that the light beams can be directed toward the substrate 10, which is disposed below the surface of the light path, as shown in a side view of FIG. 2b.

It should be mentioned that since the two light beams form a light pattern by light interference on the substrate 10, the tilt mirrors 60 can be arranged so that a predetermined pattern can be provided on the substrate 10 as the light pattern. It should be noted that the two tilt mirrors 60 disposed near the substrate 10, which are shown in FIG. 2b, can be set rotatable and movable, so that the two light beams reflected onto the substrate are adjusted to form different density string of the light pattern. Meanwhile, the other mirrors 50 in FIG. 2a can be fixed to ensure the light paths of the light beams toward the two mirrors 60 disposed near the substrate 10.

Thus, the probes of the probe solution 20 moves and are gathered in the light region of the light pattern, and can be fixed on the substrate 10 with a certain fixation method.

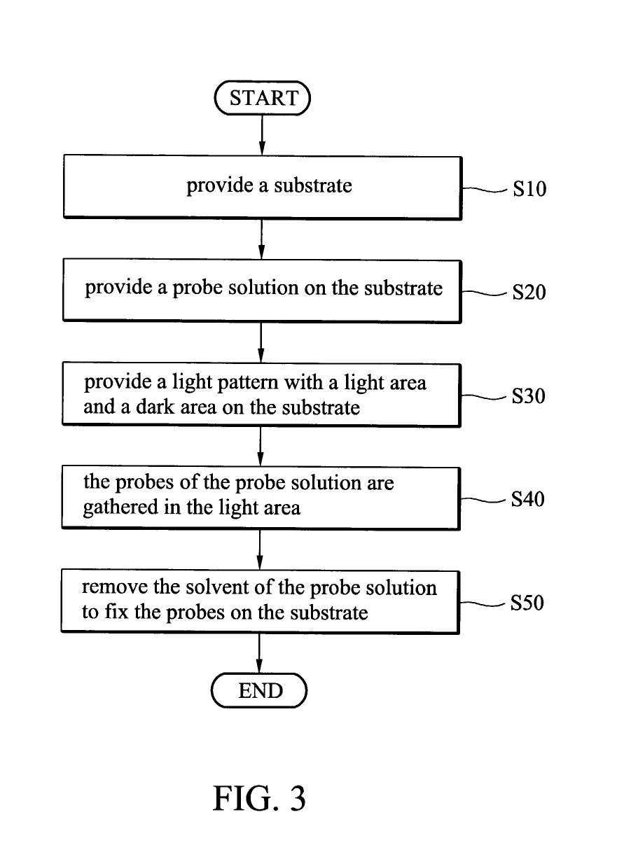

According to the embodiment, the method of fabricating a grating-based optical biosensor can be further described with reference to the flowchart of FIG. 3.

When a grating-based optical biosensor is to be fabricated, a substrate 10 for the biosensor is provided (step S10), and a probe solution 20 is provided on the substrate 10 (step S20), as shown in FIG. 1. The probe solution 20 has a plurality of probes and a solvent, in which the probes can be the probes, such as antigens, antibodies, ligands, receptors, peptides, nucleotides, or particles with these species combined thereon, as well as the specific gel capable of responding to a stimulus, as described in U.S. Pat. No. 6,180,288. The particles of the present invention can be gathered or trapped by light and the desirable particle size ranges from a diameter of approximately 1 nm to 100 um.

Then, a light pattern having a light area and a dark area is provided on the substrate 10 (step S30), so that the probe solution is exposed to the light pattern. The light pattern can be preferably obtained by the above-mentioned apparatus, in which the laser light source 30 directs a laser beam toward the beam splitter 40, the beam splitter 40 splits the laser beam into two light beams, and the tilt mirrors 60 reflect the two light beams respectively onto the substrate 10 to form the light pattern by light interference.

In this case, the probes of the probe solution 20 are gathered in the light area of the light pattern (step 40). It should be noted that the probes can be pushed toward the surface of substrate 10 by increasing the energy of the laser beam, since the axial force along the light beams that pushes the probes corresponds to the energy. Then, the probes are fixed on the substrate, and the solvent is removed from the probe solution (step S50).

It should be noted that the probes can be fixed on the substrate 10 by removing the solvent. For example, the solvent can be removed by evaporation, such as by uniformly warming the substrate to accelerate the evaporation rate of the solvent, so that the probes are fixed on the substrate 10. Otherwise, the probes can be provided with a plurality of functional groups thereon, so that the probes are fixed on the substrate 10 by activating the functional groups with light. Meanwhile, any other suitable probe fixation methods may be applied for enhancement to fix the probes on the substrate 10.

Finally, when the grating-based optical biosensor is obtained, a detection of presence of the analyte on the biosensor can be performed. For example, the detection can be performed by detecting the pattern form of the biosensor with diffraction of the reflected light.

With the method of the present invention, the grating-based optical biosensor may be fabricated without using expensive optical devices, so each optical biosensor has a relatively low cost, and the probe distribution on the optical biosensor can be kept delicate as in the conventional grating-based optical biosensor fabricated with light diffraction.

While the present invention has been described with reference to the preferred embodiments thereof, it is to be understood that the invention is not limited to the described embodiments or constructions. On the contrary, the invention is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of fabricating a grating-based optical biosensor, comprising the steps of:
(a) providing a substrate;
(b) providing a probe solution on the substrate, the probe solution comprising a plurality of probes and a solvent;
(c) providing a light pattern on the substrate, the light pattern comprising a light area and a dark area, wherein the probes of the probe solution are gathered in the light area; and
(d) fixing the probes on the substrate.

2. The method of fabricating a grating-based optical biosensor according to claim 1, wherein the step (c) further comprises:
providing a laser light source for directing a laser beam along a light path; and
providing a beam splitter and a plurality of mirrors in the light path, the beam splitter splitting the laser beam to two light beams, and the mirrors reflecting the two light beams respectively onto the substrate to form the light pattern by light interference.

3. The method of fabricating a grating-based optical biosensor according to claim 1, wherein the probe is an antigen, an antibody, a ligand, a receptor, a peptide, a nucleotide, or a particle with these species combined thereon.

4. The method of fabricating a grating-based optical biosensor according to claim 3, wherein the particle is gathered or trapped by light.

5. The method of fabricating a grating-based optical biosensor according to claim 3, wherein the particle size ranges from a diameter of approximately 1 nm to 100 um.

6. The method of fabricating a grating-based optical biosensor according to claim 1, wherein the probe is a specific gel capable of responding to a stimulus.

7. The method of fabricating a grating-based optical biosensor according to claim 1, wherein the probes are fixed on the substrate by removing the solvent in the step (d).

8. The method of fabricating a grating-based optical biosensor according to claim 7, wherein the solvent is removed by evaporation.

9. The method of fabricating a grating-based optical biosensor according to claim 7, wherein the solvent is removed by uniformly warming the substrate to accelerate evaporation rate of the solvent.

10. The method of fabricating a grating-based optical biosensor according to claim 1, wherein the probes are provided with a plurality of functional groups thereon, and the probes are fixed on the substrate by activating the functional groups with light in the step (d).

11. An apparatus for fabricating a grating-based optical biosensor, comprising:
a laser light source for directing a laser beam along a light path;
a beam splitter provided in the light patch for splitting the laser beam to two light beams; and
a plurality of mirrors disposed for reflecting the two light beams respectively onto a substrate to form a light pattern by light interference, wherein a probe solution comprising a plurality of probes and a solvent is provided on the substrate, and the probes of the probe solution are gathered in a light region of the light pattern.

12. The apparatus for fabricating a grating-based optical biosensor according to claim 11, wherein t wherein the probe is an antigen, an antibody, a ligand, a receptor, a peptide, a nucleotide, or a particle with these species combined thereon.

13. The apparatus for fabricating a grating-based optical biosensor according to claim 12, wherein the particle is gathered or trapped by light.

14. The apparatus of fabricating a grating-based optical biosensor according to claim 12, wherein the particle size ranges from a diameter of approximately 1 nm to 100 um.

15. The apparatus for fabricating a grating-based optical biosensor according to claim 11, wherein the probe is a specific gel capable of responding to a stimulus.

16. The apparatus for fabricating a grating-based optical biosensor according to claim 11, wherein the probes are fixed on the substrate by removing the solvent in the step (d).

17. The apparatus for fabricating a grating-based optical biosensor according to claim 16, wherein the solvent is removed by evaporation.

18. The apparatus for fabricating a grating-based optical biosensor according to claim 16, wherein the solvent is removed by uniformly warming the substrate to accelerate evaporation rate of the solvent.

19. The apparatus for fabricating a grating-based optical biosensor according to claim 11, wherein the probes are provided with a plurality of functional groups thereon, and the probes are fixed on the substrate by activating the functional groups with light in the step (d).
